(19) United States
(12) Patent Application Publication
(10) Pub. No.: US 2016/0197849 A1
(43) Pub. Date: Jul. 7, 2016

(54) Method and Apparatus for Implementing a Messaging Interface

(71) Applicant: McKesson Corporation, San Francisco, CA (US)

(72) Inventors: Bryan Self, Birmingham, AL (US); John Stanton, Hoover, AL (US); Balaji Varadhan, Pelham, AL (US)

(21) Appl. No.: 14/591,033

(22) Filed: Jan. 7, 2015

(51) Int. Cl. H04L 12/911; H04L 12/58

(52) U.S. Cl. CPC H04L 47/825; H04L 51/066

(57) ABSTRACT

A method, apparatus and computer program product are provided in order to provide improved messaging interfaces. Examples of a method include establishing a first listener thread to identify incoming message traffic from a Health Level 7 (HL7) repeater, initializing one or more device interfaces accessible to at least one application executing on the computing device, receiving at least one message from the HL7 repeater, associating a message queue and a second listener thread with the HL7 repeater, wherein the second listener thread includes a socket configured to receive messages from the HL7 repeater, associating the message queue and the second listener thread with at least one of the device interfaces, receiving another message from the HL7 repeater, placing, by the second listener thread, the another message on the message queue, and making the another message as stored on the message queue available to an application via the at least one of the device interfaces.

### TECHNOLOGICAL FIELD

Example embodiments of the present invention relate generally to methods and devices for network communications and, more particularly, to methods and apparatuses for providing messaging interfaces via device files.

### BACKGROUND

As network technology has advanced, it is more and more common for common business functions to be performed by computers in communication with one another. However, different fields and industries often have different requirements for information transmission, security, data retention, and the like. As such, information systems in a given industry often communicate via particular formats unique to the use, business type, technological field, or the like within the industry. Over time, standards may be developed and adopted within the industry. One example standard that has emerged is the Health Level 7 (HL7) message format used in the clinical field. This messaging format is specially designed for sending and receiving information for the exchange, integration, sharing, and retrieval of clinical information, such as electronic health records and the like.

In order to send and receive HL7 messages, each application that wishes to send or receive these messages must perform a set of network setup routines including determining the network address of any HL7 repeaters, determining an appropriate port for receiving the messages, establishing a socket, and binding to the socket. These tasks require developers of the application to write a substantial amount of code directed specifically to establishing and maintaining the network connection. For example, the application developers must typically ensure that, upon initialization, the application registers the Internet Protocol (IP) address of the host computer with a central authority, establishes a socket listening for communications from a HL7 repeater on a predetermined port, and listen for communications on that established socket and port combination. These networking operations are not trivial and require the application developer to have an intimate understanding of the network interfaces offered by the hosting computer and the configuration of the network on which the HL7 messages are being transmitted. Furthermore, even if the application developer implements these network features properly within the application, HL7 messages sent by the repeater prior to the application implementing a network interface to receive the messages may be lost forever. Through applied effort, ingenuity, and innovation, Applicant has solved many of these identified problems by developing a technical solution that is embodied by the present invention, which is described in detail below.

### BRIEF SUMMARY

Methods, apparatuses and computer program products are therefore provided according to example embodiments of the present invention in order to implement a messaging interface. Embodiments may include a method for providing a messaging interface. The method includes establishing, by processing circuitry of a computing device, a first listener thread to identify incoming message traffic from a first Health Level 7 (HL7) repeater, initializing, on the computing device, one or more device interfaces accessible to at least one application executing on the computing device, receiving, by a network interface of the computing device, at least one message from the HL7 repeater, and, in response to receiving the at least one message, associating a message queue and a second listener thread with the HL7 repeater. The second listener thread includes a socket configured to listen on the network interface to receive messages from the first HL7 repeater. The method also includes associating the message queue and the second listener thread with at least one of the device interfaces, receiving, by the network interface and via the second listener thread, another message from the HL7 repeater, placing, by the second listener thread, the another message on the message queue, and making the another message stored on the message queue available to the at least one application via the at least one of the device interfaces.

In some embodiments, the method also includes storing an association between the at least one device interface and the first HL7 repeater in a file, and accessing, by the application, the file to identify the first HL7 repeater associated with the at least one device interface. The method may also include retrieving, by the application, the another message via the device interface, and removing the another message from the message queue in response to the application retrieving the another message. The method may also include converting, by the second listener thread, the another message to a markup representation prior to placing the another message on the message queue. The method may also include disabling conversion of the another message to a markup representation in response to receiving an ioctl( ) system call. In some embodiments, the method includes receiving a second message from a second HL7 repeater; and associating the second HL7 repeater with a second device interface, a second message queue, and a third listener thread. The first listener thread may be executed as part of a kernel module. The socket may be a transmission control protocol (TCP) socket. The application may be at least one of a medical records application, a hospital admissions system, or a picture archive and communications system.

Embodiments also provide an apparatus for implementing a message interface. The apparatus includes a network interface messaging management circuitry, device management circuitry, and medical function circuitry. The messaging management circuitry is configured to establish a first listener thread to identify incoming message traffic from a first Health Level 7 (HL7) repeater, to initialize one or more device interfaces accessible to at least one application executing on the computing device and managed by device management circuitry, to receive, by the network interface, at least one message from the first HL7 repeater, in response to receiving the at least one message, to associate a message queue and a second listener thread with the first HL7 repeater, wherein the second listener thread includes a socket configured to listen on the network interface to receive messages from the HL7 repeater, and to associate the message queue and the second listener thread with at least one of the device interfaces. The device management circuitry is configured to receive, by the network interface and via the second listener thread, another message from the HL7 repeater, to place the another message on the message queue, and to make message contents of the message queue available via the at least one of the device interfaces. The medical function circuitry is configured to access the device interface to obtain the another message, and to implement the functionality of at least one application.

In some embodiments, the messaging management circuitry is further configured to store an association between the at least one device interface and the HL7 repeater in a file, and the medical function circuitry is further configured to access the file to identify the HL7 repeater associated with the at least one device interface. The medical function circuitry may be further configured to retrieve the another message via the device interface, and the device management circuitry may be further configured to remove the another message from the message queue in response to the application retrieving the another message. The device management circuitry may be further configured to convert the another message to a markup representation prior to placing the another message on the message queue. The device management circuitry may be further configured to disable conversion of the another message to a markup representation in response to receiving an ioctl( ) system call. The messaging management circuitry may be further configured to receive a second message from a second HL7 repeater, and to associate the different HL7 repeater with a second device interface, a second message queue, and a third listener thread. The first listener thread may be executed as part of a kernel module. The socket may be a transmission control protocol (TCP) socket. The application may be at least one of a medical records application, a hospital admissions system, or a picture archive and communications system.

Yet further embodiments provide a non-transitory computer readable storage medium comprising instructions that, when executed by a processor, cause the processor to configure an apparatus. The instructions cause the processor to configure the apparatus to establish a first listener thread to identify incoming message traffic from a first Health Level 7 (HL7) repeater, to initialize one or more device interfaces accessible to at least one application executing on the computing device, to receive, by a network interface of the computing device, at least one message from the HL7 repeater, in response to receiving the at least one message, to associate a message queue and a second listener thread with the HL7 repeater, wherein the second listener thread includes a socket configured to listen on the network interface to receive messages from the first HL7 repeater, to associate the message queue and the second listener thread with at least one of the device interfaces, to receive, by the network interface and via the second listener thread, another message from the HL7 repeater, to place, by the second listener thread, the another message on the message queue, and to make the another message stored on the message queue available to the at least one application via the at least one of the device interfaces. The first listener thread may be executed as part of a kernel module.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 is a block diagram of an apparatus for providing a messaging interface that may be specially configured in accordance with example embodiments of the present invention;

FIG. 2 is a block diagram of a dataflow between logical components of a computing device employing a messaging interface in accordance with example embodiments of the present invention;

FIG. 3 is a flow diagram illustrating an example of a process for initializing a messaging interface in accordance with example embodiments of the present invention;

FIG. 4 is a flow diagram illustrating an example of a process for processing an incoming message using a messaging interface in accordance with example embodiments of the present invention; and

FIG. 5 is a flow diagram illustrating an example of a process for interacting with a messaging interface in accordance with example embodiments of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

### Introduction

A method, apparatus and computer program product are provided in accordance with example embodiments of the present invention for providing a messaging interface. As noted above, the inventors have identified that requiring application developers to implement network interfaces separately in their applications in order to communicate via special-purpose messaging protocols often results in inefficient application performance, duplication of developer effort, errors in sending and receiving messages, and lost messages due to the inability to receive messages when the application is not executing. To address these problems, the inventors have developed methods and systems for providing a messaging interface in a robust, flexible manner that allows an application to communicate according to the messaging protocol without having to separately implement a complete network interface. In particular, embodiments may provide the ability to send and receive Health Level 7 (HL7) messages via implementation of an operating system device, with processing of the messages performed via an operating system structure such as a kernel module.

Embodiments may establish a separate device for multiple message originators. In some embodiments, a message management module may identify the presence of message originators and, upon detection of a message originator, establish a separate device instance for the detected message originator. The device instance may be associated with a particular thread that includes a network interface for the message originator, and one or more message queues for sending and receiving information to and from the message originator. Messages may be consumed by one or more applications by interacting with the device instance. For example, the device instance may be a “device file” or “device node” as implemented in operating systems such as UNIX® or Linux®.

Information regarding message originators that have been registered by the message management module may be stored in volatile or non-volatile storage. For example, messages indicating which message originator (e.g., an Internet Protocol (IP) address for the message originator) may be stored in a file along with an identifier for the particular device instance associated with the message originator, to allow applications to determine which device instance should be accessed to send or receive data from a particular message originator.

### Example Client Apparatus

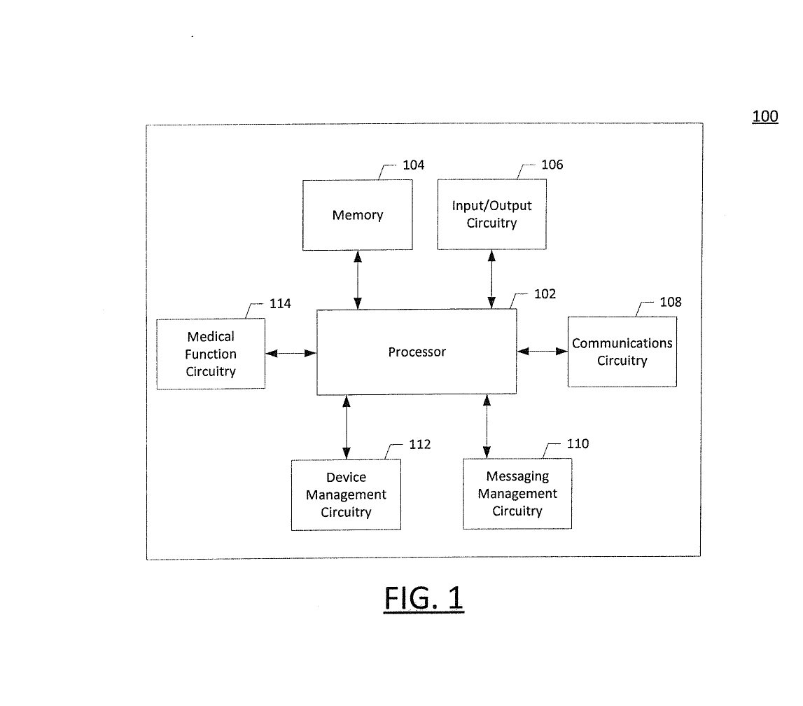

FIG. 1 illustrates a block diagram of an apparatus 100 in accordance with some example embodiments. The apparatus 100 may be any computing device capable of establishing a message interface as described herein. For example, the apparatus 100 may be implemented as any device capable of establishing a connection with a message originator, such as a HL7 repeater, and providing messages to and from the message repeater to one or more applications. The apparatus 100 may be implemented as a standalone or rack-mounted server, a desktop computer, a laptop computer, a personal digital assistant, a tablet computer, a netbook computer, a picture archiving and communication system (PACS) workstation, or the like. The apparatus 100 may be operable to establish device interfaces for message originators such that applications executing on the apparatus 100 may send and receive messages to and from message originators without having to perform network setup routines for each message originator. Accordingly, it will be appreciated that the apparatus 100 may comprise an apparatus configured to implement and/or otherwise support implementation of various example embodiments described herein.

It should be noted that the components, devices or elements illustrated in and described with respect to FIG. 1 below may not be mandatory and thus some may be omitted in certain embodiments. Additionally, some embodiments may include further or different components, devices or elements beyond those illustrated in and described with respect to FIG. 1.

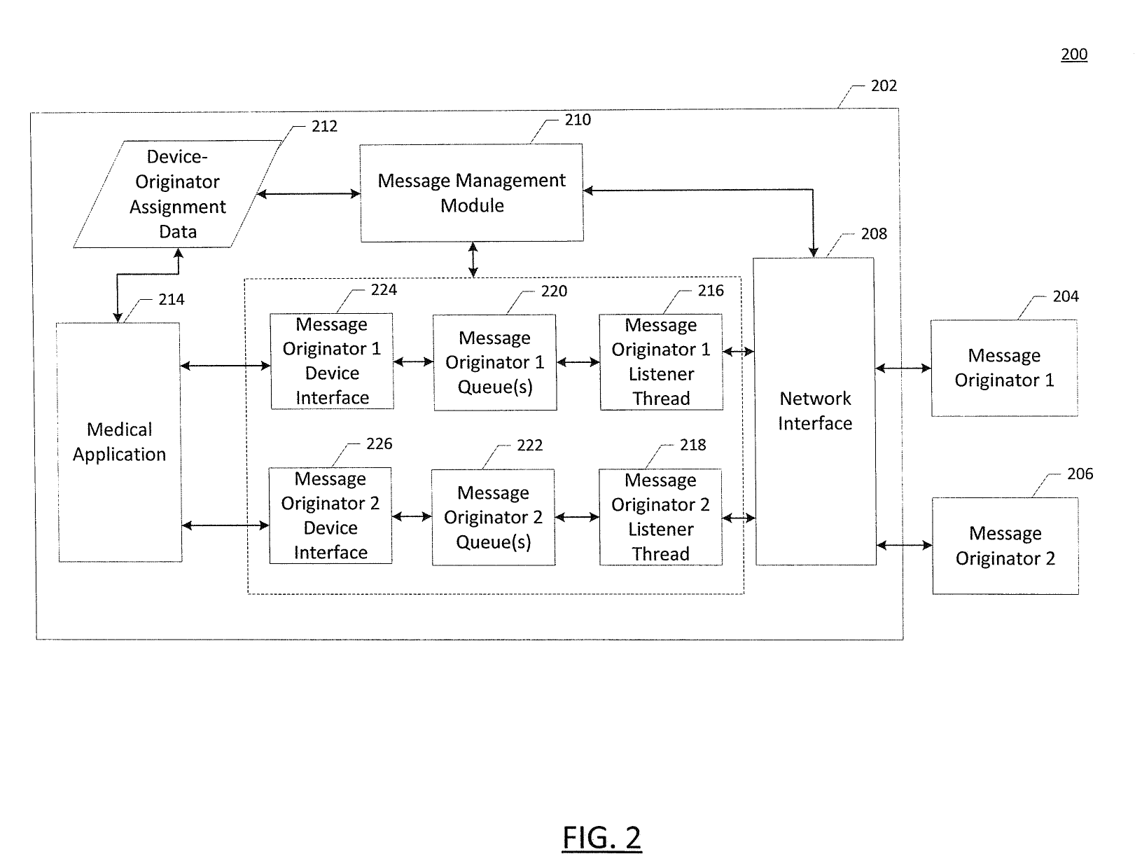

As illustrated in FIG. 1, an apparatus 100 may include a processor 102, a memory 104, input/output circuitry 106, communications circuitry 108, messaging management circuitry 110, device management circuitry 112, and medical function circuitry 114. The apparatus 100 may be configured to execute the operations described below with respect to FIGS. 2-5. Although these components 102-114 are described with respect to functional limitations, it should be understood that the particular implementations necessarily include the use of particular hardware. It should also be understood that certain of these components 102-114 may include similar or common hardware. For example, two sets of circuitry may both leverage use of the same processor, network interface, storage medium, or the like to perform their associated functions, such that duplicate hardware is not required for each set of circuitry. The use of the term “circuitry” as used herein with respect to components of the apparatus should therefore be understood to include particular hardware configured to perform the functions associated with the particular circuitry as described herein.

The term “circuitry” should be understood broadly to include hardware and, in some embodiments, software for configuring the hardware. For example, in some embodiments, “circuitry” may include processing circuitry, storage media, network interfaces, input/output devices, and the like. In some embodiments, other elements of the apparatus 100 may provide or supplement the functionality of particular circuitry. For example, the processor 102 may provide processing functionality, the memory 104 may provide storage functionality, the communications circuitry 108 may provide network interface functionality, and the like.

In some embodiments, the processor 102 (and/or co-processor or any other processing circuitry assisting or otherwise associated with the processor) may be in communication with the memory 104 via a bus for passing information among components of the apparatus. The memory 104 may be non-transitory and may include, for example, one or more volatile and/or non-volatile memories. In other words, for example, the memory may be an electronic storage device (e.g., a computer readable storage medium). The memory 104 may be configured to store information, data, content, applications, instructions, or the like, for enabling the apparatus to carry out various functions in accordance with example embodiments of the present invention.

The processor 102 may be embodied in a number of different ways and may, for example, include one or more processing devices configured to perform independently. Additionally or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In an example embodiment, the processor 102 may be configured to execute instructions stored in the memory 104 or otherwise accessible to the processor. Alternatively or additionally, the processor may be configured to execute hard-coded functionality. As such, whether configured by hardware or software methods, or by a combination thereof, the processor may represent an entity (e.g., physically embodied in circuitry) capable of performing operations according to an embodiment of the present invention while configured accordingly. Alternatively, as another example, when the processor is embodied as an executor of software instructions, the instructions may specifically configure the processor to perform the algorithms and/or operations described herein when the instructions are executed.

In some embodiments, the apparatus 100 may include input/output circuitry 106 that may, in turn, be in communication with processor 102 to provide output to the user and, in some embodiments, to receive an indication of a user input. The input/output circuitry 106 may comprise a user interface and may include a display and may comprise a web user interface, a mobile application, a client device, a kiosk, or the like. In some embodiments, the input/output circuitry 106 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 104, and/or the like).

The communications circuitry 108 may be any means such as a device or circuitry embodied in either hardware or a combination of hardware and software that is configured to receive and/or transmit data from/to a network and/or any other device, circuitry, or module in communication with the apparatus 100. In this regard, the communications circuitry 108 may include, for example, a network interface for enabling communications with a wired or wireless communication network. For example, the communications circuitry 108 may include one or more network interface cards, antennae, buses, switches, routers, modems, and supporting hardware and/or software, or any other device suitable for enabling communications via a network. Additionally or alternatively, the communication interface may include the circuitry for interacting with the antenna(s) to cause transmission of signals via the antenna(s) or to handle receipt of signals received via the antenna(s).

The messaging management circuitry 110 includes hardware configured to create and manage one or more device interfaces for establishing and maintaining communications with one or more message originators in communication with the apparatus. The messaging management circuitry 110 may function to detect the presence of a message originator and, in response to detection of the message originator, initialize one or more devices and associated managers for those devices.

The messaging management circuitry 110 may detect the presence of the message originator by identifying an incoming message from the message originator via a communications interface, such as the communications circuitry 108. Creation and management of the device interfaces may be performed by processing circuitry, such as the processor 102. It should also be appreciated that, in some embodiments, the messaging management circuitry 110 may include a separate processor, specially configured field programmable gate array (FPGA), or application specific interface circuit (ASIC) to interface with display devices. The messaging management circuitry 110 is therefore implemented using hardware components of the apparatus configured by either hardware or software for implementing these planned functions.

The device management circuitry 112 includes hardware configured to receive incoming messages from one or more message originators and to provide said incoming messages to one or more applications via one or more device interfaces. The device management circuitry 112 may include one or more network interfaces to receive network messages from message originators. The device management circuitry 112 may facilitate formatting of these incoming messages to a format that can be consumed by one or more applications without requiring those applications to establish separate network interfaces. In some embodiments, the device management circuitry 112 may format incoming messages into a markup language format, such as Extensible Markup Language (XML). The device management circuitry 112 may further maintain one or more message queues associated with each message originator. In some embodiments, each message originator may have two message queues established, one for receiving data from the message originator and one for sending data to the message originator. As applications read data from a device interface associated with the message originator, data may be consumed from the queue. The device management circuitry 112 may include one or more communications interfaces for sending and receiving data to and from the message originators. Such communications interfaces may be provided by the communications circuitry 108. The device management circuitry 112 may utilize processing circuitry, such as the processor 102, to perform these actions. It should also be appreciated that, in some embodiments, the device management circuitry 112 may include a separate processor, specially configured field programmable gate array (FPGA), or application specific interface circuit (ASIC) to provide for management of device interfaces associated with message originators. The device management circuitry 112 is therefore implemented using hardware components of the apparatus configured by either hardware or software for implementing these planned functions.

The medical function circuitry 114 includes hardware configured to perform a particular function related to the medical context. For example, the medical function circuitry may be configured to provide management of patient electronic health records, management of a hospital admission system, management of a medical picture archive and communications system (PACS), or the like. The medical function circuitry 114 may interact with one or more devices enabled by the device management circuitry 112 to send and receive messages related to the functioning of the medical function circuitry 114. For example, the medical function circuitry 114 may send and receive HL7 messages using device interfaces managed by the device management circuitry 112. It should also be appreciated that, in some embodiments, the medical function circuitry 114 may include a separate processor, specially configured field programmable gate array (FPGA), or application specific interface circuit (ASIC) to generate the context data. The medical function circuitry 114 is therefore implemented using hardware components of the apparatus configured by either hardware or software for implementing these planned functions.

As will be appreciated, any such computer program instructions and/or other type of code may be loaded onto a computer, processor or other programmable apparatus's circuitry to produce a machine, such that the computer, processor other programmable circuitry that execute the code on the machine create the means for implementing various functions, including those described herein.

It is also noted that all or some of the information presented by the example displays discussed herein can be based on data that is received, generated and/or maintained by one or more components of apparatus 100. In some embodiments, one or more external systems (such as a remote cloud computing and/or data storage system) may also be leveraged to provide at least some of the functionality discussed herein.

As described above and as will be appreciated based on this disclosure, embodiments of the present invention may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

Having now described an apparatus configured to implement and/or support implementation of various example embodiments, features of several example embodiments will now be described. It will be appreciated that the following features are non-limiting examples of features provided by some example embodiments. Further, it will be appreciated that embodiments are contemplated within the scope of disclosure that implement various subsets or combinations of the features further described herein. Accordingly, it will be appreciated that some example embodiments may omit one or more of the following features and/or implement variations of one or more of the following features.

### Example Message Interface Management Data Flow

FIG. 2 is an illustration of an example data flow 200 for providing a device interface for accessing network messages in accordance with example embodiments of the present invention. The data flow 200 illustrates communications between and among components of an apparatus 202 and one or more message originators 204, 206. As noted above, the message originators 204, 206 may be any type of network device or apparatus capable of sending and/or receiving message traffic according to a particular messaging protocol or standard. For example, the message originators may be HL7 repeaters. The apparatus 202 may be an apparatus for implementing one or more medical applications 214 in communication with the message originators 204, 206. The medical application 214 may be, for example, a patient electronic health records system, a hospital admission system, a medical image archiving system, or the like. It should be appreciated that while example embodiments are described with specific reference to a HL7 messaging architecture and standard, other embodiments may be implemented using various additional or alternative protocols and standards. Furthermore, although example embodiments are described with respect to medical applications, it should be appreciated that other types of applications could also be employed outside of a medical context.

A message management module 210 may facilitate communication between the medical application 214 and the message originators 204, 206. To do so, the message management module 210 may monitor a network interface 208 (e.g., one or more network interface cards, device drivers, or the like) to detect incoming traffic from one or more message originators. Upon detection of an incoming message from one of the message originators, the message management module 210 may initialize one or more components of the apparatus 200 to handle message processing for further messages received from the message originator. For example, the message management module 210 may listen for communications on a predetermined port (e.g., port 1984). Upon receiving a communication upon the predetermined port, the message management module 210 may initialize the various components of example embodiments as described herein.

The message management module 210 may be implemented as an operating system structure. For example, in some embodiments the message management module 210 is a kernel module that, when initialized, begins listening for HL7 message traffic. Upon detection of a HL7 repeater, the kernel module may establish a device interface (e.g., /dev/HL70, /dev/HL71, or the like) for the particular HL7 repeater. In some embodiments, the message management module 210 may be dynamically inserted into a running operating system kernel. Upon insertion of the message management module 210, the message management module 210 may enable one or more device interfaces to later be associated with the message originators upon detection of a message originator. In some embodiments, upon disabling the message management module or unloading the message management module 210 from the kernel, all device interfaces and associated listener threads and message queues may be disabled and the attendant memory, processing, and network resources released.

Detection of a message originator 204, 206 may cause the message management module 210 to initialize a listener thread 216, 218, one or more message queues 220, 222, and a device interface 224, 226 for each message originator. When initialization of the device interface 224, 226 for a particular message originator 204, 206 is complete, the message management module 210 may generate or modify a set of device-originator assignment data 212. The device-originator assignment data 212 may include information identifying particular message originators and the device interface 224, 226 assigned to the particular message originator (e.g., an association between a particular IP address and a particular device interface).

The listener thread 216, 218 may identify incoming message traffic from an associated message originator as message traffic is received from the network interface 208. For example, the listener thread 216, 218 may maintain a transmission control protocol (TCP) socket associated with the particular message originator that listens on a particular port for messages from the message originator. Upon detection of a message from the associated message originator, the listener thread 216, 218 may process the message and append the message to the associated message queue 220, 222. Detection of a message from the associated repeater may be performed by the listener thread 216, 218 by listening for traffic from a particular IP address, on a particular port, or the like. The listener thread 216, 218 may identify traffic associated with a message and construct the message from the traffic. For example, a given message may be transmitted via a plurality of packets and the listener thread 216, 218 may assemble those packets into a complete message before appending the message to the associated queue 220, 222. In some embodiments, the listener thread 216, 218 may also format the message, such as by converting the message to a markup language format.

The message originator queues 220, 222 may receive messages from the listener threads 216, 218 and maintain a queue structure to store the messages until they are consumed by the medical application 214. In some embodiments, the message queues may have a maximum size, and if the messages stored in the queue exceed the maximum size, further messages may be discarded. In some embodiments, when a queue is full and a new message is received, the oldest message may be discarded. Messages may be consumed from the queue by the medical application 214 interacting with a device interface associated with the queue.

Each message originator 204, 206 may be associated with a particular device interface 224, 226 which is assigned, allocated, and/or created by the message management module 210. The device interface 224, 226 may provide a mechanism by which the medical application 214 may obtain messages from a message originator 204, 206 without requiring the medical application 214 to do anything more than open a device file or device node. In this manner, the message management module 210 may establish functions and routines associated with the device interface 224, 226 that allow the device interface to read data off the associated message queue, provide the data to a medical application, notify the queue that data has been read, and the like. Some embodiments may also include mechanisms for sending data back to the message originator using the same device interface, such as by using a parallel queue to send data in a similar manner in which data is received.

The use of a device interface in this manner allows the medical application 214 to receive message data via a straightforward process. Instead of having to manually and separately establish a network interface for the application itself, the network functionality is instead handled by the message management module 210 and the medical application 214 can send data as easily as writing to the associated device interface (e.g., by writing to a device file). Furthermore, as illustrated in the dataflow 200, embodiments may leverage access to multiple device interfaces 224, 226 to interact with multiple message originators 204, 206. The use of a separate listener thread 216, 218 and queue 220, 222 for each message originator 204, 206 also ensures that message traffic from the particular originator is not lost if the medical application 214 has not yet been initialized at the time the message traffic is sent.

To retrieve messages from a particular message originator, the medical application 214 may perform a read operation on the device interface 224, 226 associated with the particular message originator 204, 206. To determine which interface is associated with which message originator, the medical application 214 may consult the device-originator assignment data 212.

### Example Processes for Providing a Messaging Interface

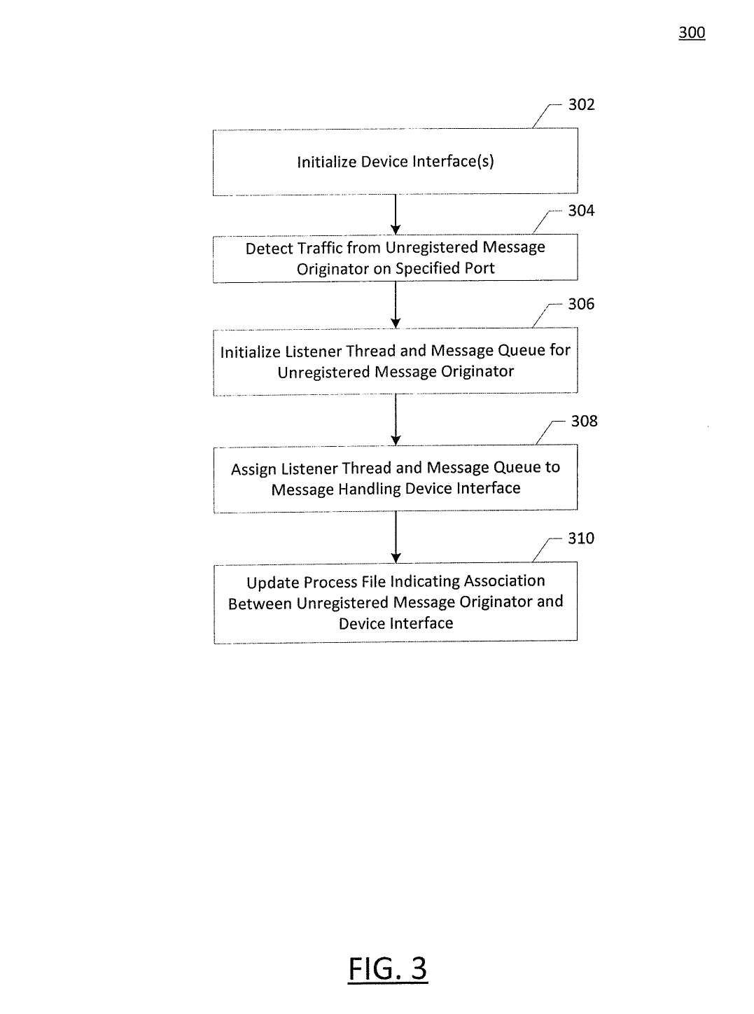

FIG. 3 is a flow diagram illustrating an example of a process 300 for initializing a message interface in accordance with example embodiments of the present invention. The process 300 is operable to detect the presence of message originators and to establish and initialize processes and data structures for processing messages received from those message originators. Embodiments of the process may be performed by an apparatus, such as the apparatus 100 described with respect to FIG. 1, and as part of a message handling system as depicted with respect to FIG. 2.

At action 302, one or more device interfaces are initialized. In the present examples, the device interfaces are initialized prior to detection of a message originator, though it should be appreciated that in some embodiments the device interfaces are initialized in response to detection of a message originator. Initialization of the device interface may include creation of a device file by a component of an operating system. For example, a kernel module may establish one or more device files /dev/HL70, /dev/HL71, /dev/HL72, or the like to be associated with message originators upon detection of said message originators. Some embodiments may initialize a predetermined number of device interfaces upon initialization of a kernel module. For example, a given embodiment may initialize 3, 5, or 10 device interfaces to be associated with particular message originators.

At action 304, traffic for an unregistered message originator is detected on a predetermined port. As described above with respect to FIG. 2, embodiments may employ a thread that listens for message originator traffic via a network interface. The message originator traffic may occur via a predetermined TCP port, and upon detecting traffic on the predetermined TCP port that is not already registered to a device interface, the process may proceed to action 306 where a listener thread and a message queue are initialized for the particular message originator.

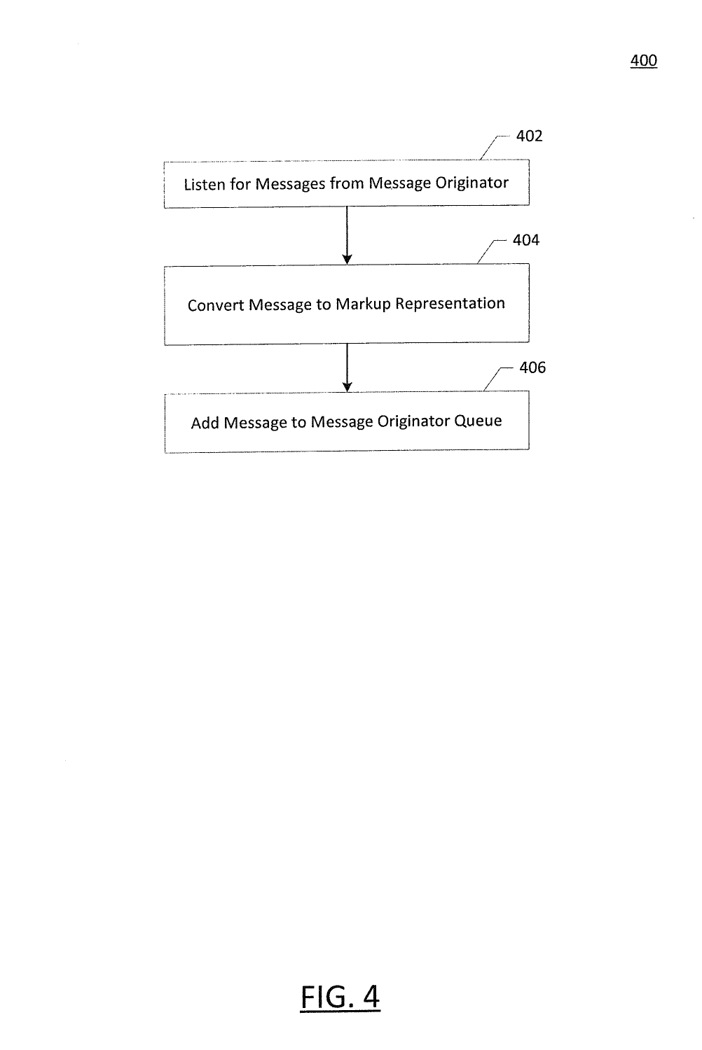

Upon initialization, the listener thread may open a TCP socket to listen for traffic from the message originator. An example embodiment of a process for receiving message traffic via the listener thread is described further below with respect to FIG. 4. At action 308, the listener thread and message queue may be associated with one of the device interfaces established at action 302. Association of a listener thread and message queue with a particular device interface may enable the device interface to begin receiving messages from the listener thread via the message queue.

At action 310, an association between the message originator and the device interface is saved, logged, or otherwise tracked in a structure that is accessible to an application seeking to receive messages via the device interface. For example embodiments may employ a “procfile” to store associations between particular message originators (e.g., their associated IP address) and particular devices. Once the association between the device interface and the message originator is stored, applications may begin using the device interface to receive messages from the message originator.

FIG. 4 is a flow diagram illustrating an example of a process 400 for processing an incoming message using a messaging interface in accordance with example embodiments of the present invention. As described above, embodiments may allow applications to access message traffic from one or more message originators through one or more device interfaces. Embodiments of the process 400 illustrate how such messages may be made available via a device interface. In particular, the process 400 illustrates an example method by which a listener thread may identify incoming network traffic from a particular message originator, process the network traffic to identify the message, and add the message to the message queue to be accessed by an application via the associated device interface. Embodiments of the process may be performed by an apparatus, such as the apparatus 100 described with respect to FIG. 1, and as part of a message handling system as depicted with respect to FIG. 2.

At action 402, a listener thread that has been established for a particular message originator listens for message traffic from that particular message originator. For example, the listener thread may monitor a TCP socket created to receive traffic from a particular IP address on a particular port. Upon identifying traffic from the particular message originator, the listener thread may receive incoming data packets until a message is constructed.

At action 404, the message may optionally be converted into a markup representation. In some embodiments, the listener thread may place the message on the queue without further processing, while in other embodiments the message may be converted to a markup representation, such as XML, before being made available via a device interface. Particular tags of the markup representation may correspond to particular fields of the message. As such, the listener thread may be configured to parse incoming messages, to determine the individual components of the header, to identify tags to be associated with the individual components of the header, and to generate the markup representation having the appropriate tags and data values. Some embodiments may include a flag, switch, or toggle that enables or disables conversion of incoming messages to a markup language format. For example, a device may implement an ioctl( ) system call to enable or disable markup language conversion of incoming messages.

At action 406, the received message may be added to the message queue associated with the particular message originator. Once added to the queue, the message may be accessible to applications by the device interface previously established for the message originator.

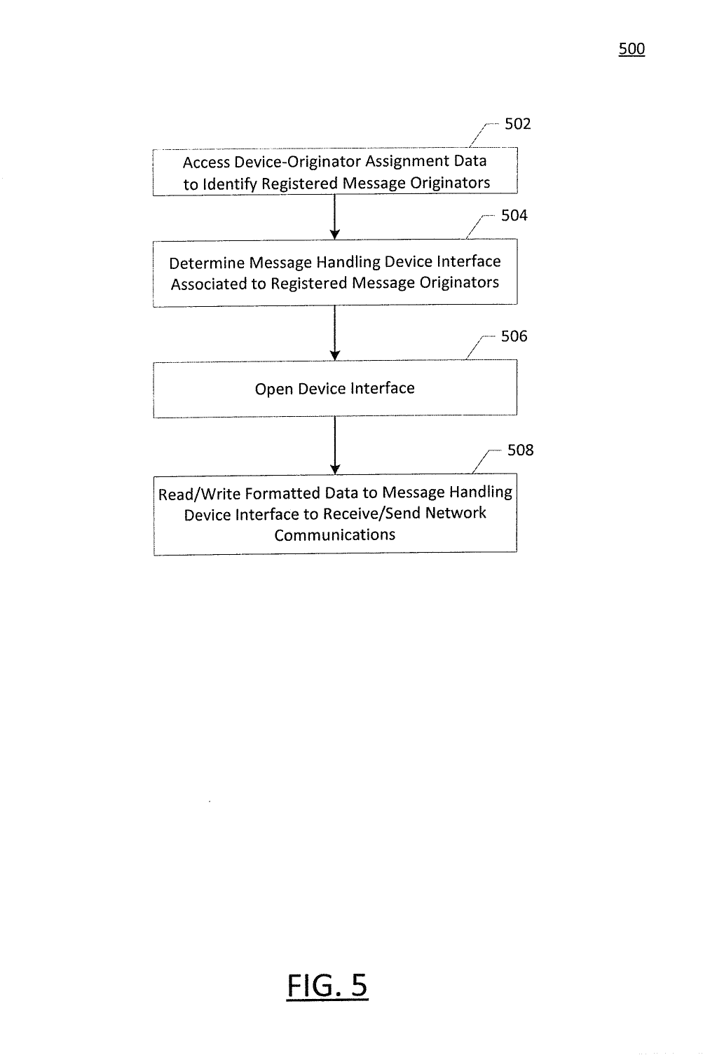

FIG. 5 is a flow diagram illustrating an example of a process 500 for interacting with a messaging interface in accordance with example embodiments of the present invention. As noted above, applications may access established device interfaces to obtain messages from the message originators without requiring the application to establish a separate network interface to the message originator. To this end, embodiments provide for a device interface that interacts with a message queue established for the message originator. As messages are read from the device interface by the application, the messages are removed from the queue. Some embodiments may also include an additional queue for sending messages back to the message originator. Embodiments of the process may be performed by an apparatus, such as the apparatus 100 described with respect to FIG. 1, and as part of a message handling system as depicted with respect to FIG. 2.

At action 502, an application accesses a set of device-originator assignment data to identify a particular device interface that is assigned to a message originator. As noted above, the device-originator assignment data may be stored in a “process file” or “procfile” maintained by a message management module. By accessing the device-originator assignment data, the application may be informed of which message originators are currently active and/or assigned to a device interface.

At action 504, the application identifies a device interface associated with a particular message originator. For example, the application may determine the device interface associated with a message originator having a particular IP address, or the application may select the first message originator listed in the set of device-originator assignment data.

At action 506, the application opens the device interface identified at action 504. For example, the application may open the device interface as if it were a file. The application may then read and write to the device interface at action 508 to facilitate transmission of data to and from the message originator in a manner consistent with the embodiments described above with respect to FIGS. 1-4.

It will be understood that each element of the flowcharts, and combinations of elements in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory 104 of an apparatus employing an embodiment of the present invention and executed by a processor 102 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method for providing a messaging interface, the method comprising:
establishing, by processing circuitry of a computing device, a first listener thread to identify incoming message traffic from a first Health Level 7 (HL7) repeater;
initializing, on the computing device, one or more device interfaces accessible to at least one application executing on the computing device;
receiving, by a network interface of the computing device, at least one message from the HL7 repeater;
in response to receiving the at least one message, associating a message queue and a second listener thread with the HL7 repeater, wherein the second listener thread includes a socket configured to listen on the network interface to receive messages from the first HL7 repeater;
associating the message queue and the second listener thread with at least one of the device interfaces;
receiving, by the network interface and via the second listener thread, another message from the HL7 repeater;
placing, by the second listener thread, the another message on the message queue; and
making the another message stored on the message queue available to the at least one application via the at least one of the device interfaces.

2. The method of claim 1, further comprising:
storing an association between the at least one device interface and the first HL7 repeater in a file; and
accessing, by the application, the file to identify the first HL7 repeater associated with the at least one device interface.

3. The method of claim 1, further comprising:
retrieving, by the application, the another message via the device interface; and
removing the another message from the message queue in response to the application retrieving the another message.

4. The method of claim 1, further comprising converting, by the second listener thread, the another message to a markup representation prior to placing the another message on the message queue.

5. The method of claim 1, further comprising disabling conversion of the another message to a markup representation in response to receiving an ioctl( ) system call.

6. The method of claim 1, further comprising:
receiving a second message from a second HL7 repeater; and
associating the second HL7 repeater with a second device interface, a second message queue, and a third listener thread.

7. The method of claim 1, wherein the first listener thread is executed as part of a kernel module.

8. The method of claim 1, wherein the socket is a transmission control protocol (TCP) socket.

9. The method of claim 1, wherein the application is at least one of a medical records application, a hospital admissions system, or a picture archive and communications system.

10. An apparatus for implementing a message interface, the apparatus comprising:
a network interface;
messaging management circuitry configured to:
establish a first listener thread to identify incoming message traffic from a first Health Level 7 (HL7) repeater;
initialize one or more device interfaces accessible to at least one application executing on the computing device and managed by device management circuitry;
receive, by the network interface, at least one message from the first HL7 repeater;
in response to receiving the at least one message, to associate a message queue and a second listener thread with the first HL7 repeater, wherein the second listener thread includes a socket configured to listen on the network interface to receive messages from the HL7 repeater; and
associate the message queue and the second listener thread with at least one of the device interfaces;
the device management circuitry configured to:
receive, by the network interface and via the second listener thread, another message from the HL7 repeater;
place the another message on the message queue;
make message contents of the message queue available via the at least one of the device interfaces; and
medical function circuitry configured to:
access the device interface to obtain the another message; and
implement the functionality of at least one application.

11. The apparatus of claim 10, wherein the messaging management circuitry is further configured to store an association between the at least one device interface and the HL7 repeater in a file, and the medical function circuitry is further configured to access the file to identify the HL7 repeater associated with the at least one device interface.

12. The apparatus of claim 10, wherein the medical function circuitry is further configured to retrieve the another message via the device interface, and the device management circuitry is further configured to remove the another message from the message queue in response to the application retrieving the another message.

13. The apparatus of claim 10, wherein the device management circuitry is further configured to convert the another message to a markup representation prior to placing the another message on the message queue.

14. The apparatus of claim 10 wherein the device management circuitry is further configured to disable conversion of the another message to a markup representation in response to receiving an ioctl( ) system call.

15. The apparatus of claim 10, wherein the messaging management circuitry is further configured to:
receive a second message from a second HL7 repeater; and
associate the different HL7 repeater with a second device interface, a second message queue, and a third listener thread.

16. The apparatus of claim 10, wherein the first listener thread is executed as part of a kernel module.

17. The apparatus of claim 10, wherein the socket is a transmission control protocol (TCP) socket.

18. The apparatus of claim 10, wherein the application is at least one of a medical records application, a hospital admissions system, or a picture archive and communications system.

19. A non-transitory computer readable storage medium comprising instructions that, when executed by a processor, cause the processor to configure an apparatus to:
establish a first listener thread to identify incoming message traffic from a first Health Level 7 (HL7) repeater;
initialize one or more device interfaces accessible to at least one application executing on the computing device;
receive, by a network interface of the computing device, at least one message from the HL7 repeater;
in response to receiving the at least one message, associate a message queue and a second listener thread with the HL7 repeater, wherein the second listener thread includes a socket configured to listen on the network interface to receive messages from the first HL7 repeater;
associate the message queue and the second listener thread with at least one of the device interfaces;
receive, by the network interface and via the second listener thread, another message from the HL7 repeater;
place, by the second listener thread, the another message on the message queue; and
make the another message stored on the message queue available to the at least one application via the at least one of the device interfaces.

20. The computer readable storage medium of claim 19, wherein the first listener thread is executed as part of a kernel module.
